(19) United States
(12) Patent Application Publication
(10) Pub. No.: US 2005/0065234 A1
(43) Pub. Date: Mar. 24, 2005

(54) Ink jet inks for use on textile materials, and their use

(76) Inventors: Derek Edward Wilson, Somerset (GB); Nigel Anthony Caiger, Somerset (GB); Alexander Grant, Bath (GB)

Correspondence Address: Sidney Persley;Sun Chemical Corporation, 222 Bridge Plaza South, Fort Lee, NJ, 07024, US

(21) Appl. No.: 10/491,205

(22) PCT Filed: Sep. 28, 2002
(86) PCT No.: PCT/GB02/04360

(30) Foreign Application Priority Data
Sep. 28, 2001 (GB) 0123505.0

(51) Int. Cl. C03C 17/00; C09D 5/00

(52) U.S. Cl. 523/160; 523/161

(57) ABSTRACT

An ink jet ink comprises (a) an emulsion polymer selected from acrylic-acrylonitrile polymers, butadiene-acrylonitrile polymers, styrene-acrylic polymers, acrylic-butadiene polymers and polyurethanes; (b) a cross-linking agent; (c) a pigment; and (d) a liquid medium. The ink is suitable for use in printing on textile substrates.

The present invention relates to ink jet inks. More particularly, the invention relates to ink jet inks which are suitable inter alia for use in printing upon textiles, and to the use of such inks.

Textile inks are commonly applied to textiles using a screen printing process. Those inks are in general relatively viscous, and can include a wide variety of pigment types, including those of relatively large particle size. The ink is usually present in the form of thick deposits on the material. Because of the need for the printed fabrics to endure, for example, high temperature washing and dry cleaning, it is desirable for the inks to have good high temperature resistance and chemical resistance.

The use of the ink jet printing technique for printing upon fabrics has been proposed. Ink jet printing is a non-impact method in which small droplets of ink are directed from a nozzle onto a printable substrate, which may typically be of paper, card or plastics material. Inks for use in ink jet printing are required to have a relatively low viscosity and small particle size in order to have satisfactory jetting characteristics.

Ink jet printing upon textile materials has been successfully accomplished using dye-based inks. In many cases, however, the enduring light-fastness that is required in the use of the printed textile materials is not achieved or is not satisfactorily achieved with such inks. In some cases, satisfactory light-fastness is achievable only with the use of certain fabric pre-treatments and/or post-treatments.

International Specification No. WO 00/03079 describes a process for ink jet printing onto textile materials, in which a water-based ink comprising a pigment, a pigment binder that is dispersible or soluble in water and is the polymerisation product of at least one of acrylic acid and urethane, and a humectant.

U.S. Specification No. 6,001,137 describes a process for ink jet printing of dye onto textiles in which the textile is treated, prior to the printing step, with a solution comprising a polymer or copolymer comprising an epi-halohydrin (or precursor thereof) and a polyalkylene polyamine, optionally with a softener. EP 927 787 A and U.S. Pat. No. 5,853,861 also describe processes in which the textile material is subjected to a pre-treatment.

There remains a need for ink jet inks which have good jetting characteristics, but which perform well when applied to a textile material and in particular have good light-fastness characteristics as a consequence of including pigments as colouring agents.

The present invention provides an ink jet ink for use in a process of ink jet printing upon a textile substrate comprising:
(a) an emulsion polymer selected from the group consisting of acrylic-acrylonitrile polymers, butadiene-acrylonitrile polymers, styrene-acrylic polymers, acrylic-butadiene polymers, and polyurethanes and having a glass transition temperature of not more than 50° C.;
(b) a cross-linking agent which is suitable for cross-linking the emulsion polymer;
(c) a pigment; and
(d) a liquid medium.

The above-mentioned emulsion polymers offer the possibility of ink jet inks which can have a viscosity that is sufficiently low to permit satisfactory jetting characteristics to be achieved whilst further permitting printed textiles to be obtained which, after cross-linking of the polymer, have dry- and wet-fastness comparable with that of a conventional screen ink applied by screen printing.

As indicated above, the emulsion polymer should have a glass transition temperature (“T_{g}”) of not more than 50° C. Where the emulsion polymer is made from more than one monomer, the T_{g} of the polymer can be predicted to a good approximation by the following equation (known as the Fox equation):

$$\frac{1}{{T}_{g}} = \frac{{X}_{1}}{{T}_{g1}} + \frac{{X}_{2}}{{T}_{g2}} ⋯ + \frac{{X}_{n}}{{T}_{gn}}$$

where X₁, X₂ . . . Xₙ are the mass fractions of the monomer components 1, 2 . . . n of the copolymer and T_{g1}, T_{g2} . . . T_{gn} are the T_{g} values in Kelvin of homopolymers composed in each case only of one of the monomers 1, 2 . . . n. The glass transition temperatures of such homopolymers are available from standard reference sources, for example, Polymer Handbook, 2nd Edition, J. Brandrup, E. H. Immergut, John Wiley & Sons, 1975.

In general, the acrylic-acrylonitrile, butadiene-acrylonitrile, styrene-acrylic and acrylic-butadiene polymers used in accordance with the invention will be made up essentially of two monomers. Those polymers, or the polyurethanes, used in accordance with the invention may, however, contain up to 30% by weight, for example up to 20% by weight, based on the total polymer weight, of units derived from an additional, different, monomer or monomers, provided that any such additional monomer(s) do not detrimentally interfere with the cross-linking of the polymers.

References herein to “acrylic”, “acrylonitrile”, “styrene” and “butadiene” in relation to acrylic-acrylonitrile, butadiene-acrylonitrile, styrene-acrylic and acrylic-butadiene copolymers are to be understood as including both copolymers including as monomer units acrylic acid, acrylonitrile, styrene or butadiene, respectively, and copolymers including as monomer units substituted acrylic acids, substituted acrylonitriles, substituted styrenes or substituted butadienes, respectively, provided that any substituent or substituents do not detrimentally interfere with the cross-linking of the polymers.

In general, the liquid medium will be an aqueous medium.

Preferably, the emulsion polymer is an acrylic-butadiene copolymer. It has been found that an ink jet ink comprising an acrylic-butadiene copolymer is particularly advantageous in terms of providing both good jetting characteristics and good wet- and dry-fastness in printed textiles.

Advantageously, the cross-linking agent is present in an amount of from 1.5 to 20% by weight based on the weight of emulsion polymer. Advantageously, the ink comprises up to 18% by weight emulsion polymer, based on the total weight of the ink. Preferably, the ink comprises from 2 to 18% by weight emulsion polymer, up to 1% by weight cross-linker, up to 10%, weight pigment and up to 94%, and more preferably up to 80%, by weight water, based on the total weight of the ink. Preferably, the ink comprises at least 0.1% by weight, more preferably at least 0.3% by weight, cross-linker, based on the total weight o the ink. Preferably, the ink comprises at least 0.1% by weight pigment, based on the total weight of the ink. Advantageously, the ink comprises about 1 to 5% by weight pigment, for example, about 4% by weight pigment.

The cross-linking agent may be any substance that is suitable for cross-linking the emulsion polymer. Preferably, the cross-linking agent is a melamine-formaldehyde cross-linking agent.

A preferred ink composition comprises from 3 to 18% by weight emulsion copolymer, from 0.3 to 1% cross-linking agent, from 0.1 to 8% by weight pigment and from 10 to 95% by weight, more preferably from 10 to 80% by weight, water, in each case based on the total weight of the ink, the ink optionally containing one or more additional ingredients selected from additives suitable for use in ink jet inks.

An especially preferred ink composition comprises up to 18% by weight, and for example from 3 to 15% by weight, of an acrylic-butadiene emulsion polymer, from 0.3 to 1% by weight of a melamine-formaldehyde cross-linker, from 0.1 to 10% pigment and from 10 to 80% by weight water, in each case based on the total weight of the ink, the composition optionally containing up to 70% by weight of additional ingredients selected from additives suitable for use in ink jet inks.

As the pigment, there may be used any pigment that is suitable in conventional ink jet inks. In accordance with usual usage in the art, the term “pigment” is used herein to mean a colourant that is insoluble throughout the ink jet printing process. The pigments suitable for use in the inks of the invention may be in the crystalline or amorphous or mixed crystalline-amorphous state. The inks may contain one or more pigments selected from organic pigments and inorganic pigments. Typically, the inks will contain more than one pigment. Amongst pigments that may be successfully used are the following: azo pigments (monoarylide, diarylide, naphthol, benzimidazolone, metal salt reds etc.), phthalocyanines, quinacridones and dioxazines, for example, Pigment Red 57:1, Pigment Red 52:2, Pigment Red 48:2, Pigment Blue 15:3, Pigment Green 7, Pigment Yellow 83, Pigment yellow 13, Pigment White 6, Pigment Black 7. A non-exhaustive list of examples of such pigments include the following from the Irgalite range ex Ciba:Rubine L4, Bordeaux CM, Red 2BP, Blue LG, Green GLN, Yellow B3R and Yellow LBG; as well as Tioxide RHD6 (ex Tioxide) and Special Black 250 (ex Degussa).

The pigment particles will normally have a diameter of not exceeding 50 μm, for example in the range of 0.005 to 5 μm. Pigment particles exceeding 5 μm in diameter will generally interfere with the flow of ink through the ejector nozzles of the ink jet printing device and are therefore undesirable where printing devices having conventional nozzle diameters are used. Particle sizes in the range of 0.005 to 5 μm are also advantageous in terms of the stability of the pigment dispersion, tending to reduce settling, and in terms of generating good colour strength. The pigment particle size is preferably up to 1 μm, more preferably up to 0.5 μm.

The ink may further comprise one or more additional ingredients suitable for use in ink jet inks. Any additional ingredient(s) may comprise one or more ingredients selected from the group consisting of surfactants, humectants, defoamers, dispersants, conductivity agents, thickeners, and pH regulators Where present, additional ingredients may comprise up to 70% by weight of the total ink weight.

Surfactants used in the ink may be ionic, non-ionic or amphoteric and may be included in the ink to wet the pigment an break agglomerates of primary pigment particles, disperse the pigment to develop colour strength, stabilize the pigment from settling or agglomerating, and to achieve a desired surface tension. Suitable non-ionic or amphoteric surfactants include surfactants which are fluorinated alkyl polyoxyethylene ethanols; fluorinated alkyl alkoxylates; fluorinated alkylesters; alkyl polyethylene oxides; alkyl phenyl polyethylene oxides; acetylenic polyethylene oxides; polyethylene oxide block copolymers; amines, amides, esters (such as fatty acid esters) and diesters of polyethylene oxide; sorbitane fatty acid esters; glycerine fatty acid esters; fluorinated alkyl amphoteric mixture; polyethersiloxane copolymer; organo-modified polysiloxane; dimethyl-polysiloxane blends. Suitable ionic surfactants include anionic surfactants selected from ammonium perfluoroalkyl sulfonates; lithium perfluoroalkyl sulfonates; potassium perfluoroalkyl sulfonates; fatty acid salts; alkyl sulfate ester salts; alkylaryl sulfonate salts dialkyl sulfosuccinate salts, alkyl phosphate ester salts and polyoxy ethylenealkyl sulfate ester salts. Suitable cationic surfactants include fluorinated alkyl quaternary ammonium iodides.

Surfactants, where present, may be included in an amount of up to 5% by weight, based on the total ink weight. In many cases, it will be preferred for more than one surfactant to be present. The selection of suitable surfactants and surfactant combinations will be a matter of routine for those skilled in the art of ink jet inks.

The inks may optionally include one or more humectants typically in an amount of not more than 30% for example from 2 to 30%, and preferably from 5 to 25% in each case by weight, based on the total weight of the ink. Suitable humectants include polyols, for example, ethylene glycol, diethylene glycol, propylene glycol, dipropylene glycol, glycerine, and polyethylene glycols of molecular weight up to 2000.

The ink may contain any suitable thickener, for example, one or more compatible thickeners selected from alginates, starch ethers and cellulose ethers. Preferred thickeners are cellulose ethers, especially water-soluble cellulose ethers, for example, carboxymethyl cellulose and hydroxypropyl-methyl cellulose; polyacrylic acid; polyvinylpyrrolidone; polyethylene glycol; and propylene glycol. Preferred thickeners are polyvinylpyrrolidone, polyethylene glycol and propylene glycol. Where present, the thickener(s) may constitute up to 40% by weight of the total ink weight. Certain thickeners, for example, propylene glycol, 1,3-propanediol, 1,4-butanediol, 1,5-pentanediol, 2,2-thiodiethanol, 2-pyrrolidinone or 1-methyl-2-pyrrolidinone can also be present as humectants and, in that case, the amount of the thickener/humectant may be up to 60% by weight of the total ink weight.

The ink has a viscosity which is such that it may be satisfactorily delivered by an ink jet printer. The ink may have a viscosity of up to 30 cP (mPa.s), and advantageously in the range of from 1 to 30 mPa.s, at 25° C. In the case of certain drop on demand (DOD) ink jet printers, it will be preferable for the viscosity of the ink to be from 1 to 8 mPa.s, preferably about 4 to 5 mPa.s, at 25° C. Certain other DOD printers require ink of a higher viscosity. Thus, the ink may advantageously have a viscosity in the range of 8 to 40 mPa.s, preferably from 8 to 22 mPa.s and especially 10 to 14 mPa.s at 25° C. The inks may be suitable for use in Continuous Ink Jet (CIJ) printers, and will then expediently have viscosities corresponding to those indicated above in relation to DOD printers.

The invention also provides an ink jet ink for use in a process of ink jet printing upon a textile material substrate, comprising an acrylic-butadiene emulsion polymer, a cross-linking agent for cross-linking the acrylic-butadiene emulsion polymer, a pigment, and an aqueous medium, the ink having a viscosity of not more than 40 mPa.s.

A method of printing on a textile substrate, comprising applying to the textile substrate by ink jet printing a formulation comprising:
(a) an emulsion polymer selected from the group consisting of acrylic-acrylonitrile polymers, butadiene-acrylonitrile polymers, styrene-acrylic polymers, acrylic-butadiene polymers, and polyurethanes and having a glass transition temperature of not more than 50° C.;
(b) a cross-linking agent which is suitable for cross-linking the emulsion polymer;
(c) a pigment; and
(d) an aqueous medium.

Viscosities referred to herein are as measured on a Brookfield DV-1+ Viscometer and a UL adapter spindle 0, at a shear rate of 60 rpm (for viscosities up to 6 mPa.S) or 30 rpm (for viscosities over 6 mPa.S).

The selection of suitable additive ingredients to obtain inks of the desired viscosity will be a matter of routine for those skilled in the art of ink jet inks.

The inks of the invention may be applied to textiles using most ink jet printer equipment, for example, piezoelectric printers or continuous flow printers.

After application of the ink, the printed textile material is preferably heated to initiate cross-linking. Preferably, the printed textile material is heated to a temperature of at least 100° C., for example, a temperature of from 100 to 190° C., and preferably from 100 to 175° C. The duration of the heating step will depend in part upon the temperature but will generally be from 5 seconds to 30 minutes, and preferably from 1 minute to 15 minutes. The selection of appropriate cross-linking conditions will be a matter of routine for those skilled in the art of polymer chemistry. The degree of cross-linking in the cross-linked polymer may be ascertained by infrared (IR) spectroscopy or by differential scanning calorimetry (DSC) and the development of calibration curves based on such IR or DSC measurements and/or based on performance characteristics (such as the ink rub off colour density of a textile printed under standard conditions VS cure time) will be within the normal skills of the person skilled in the art.

The inks of the invention may be applied to any suitable textile substrate. Suitable textile substrates include fabrics of natural and/or synthetic materials, for example, woven or non-woven fabrics of or comprising one or more materials selected from the group consisting of cotton, wool, linen, viscose, polyamides and polyesters. Preferred textile substrates are those containing a proportion of cotton and a proportion of synthetic fibre material. Cotton/synthetic fabrics include polycottons, which may comprise a mixture of cotton and polyester.

The following Examples illustrate the invention. Unless otherwise stated, references herein to “parts” or “%” are by weight based upon the total weight of all components present.

### EXAMPLE 1

A CIJ formulation and a DOD ink jet formulation were prepared including an acrylic-butadiene emulsion polymer having a Tg of −10° C. (available from Sun Chemical as fixative ABN Emulsion) and a melamine-formaldehyde cross-linker (Aux Clear LF, available from SunChemical KVK). The ingredients of each formulation are given in Table 1, together with the formulations viscosity, particle size, range and surface tension. The pigments were selected to give a black colour. Viscosity is as measured on a Brookfield Viscometer using the conditions mentioned above. Particle size is as measured using a Malvern Mastersizer series S. Surface tension is as measured using a Du Nouy Ring Apparatus (available from White Electrical Instrument Co Ltd). Conductivity was measured using a BA380 Conductivity Meter from EDT Instruments. The method of preparation of each ink was as follows:

TABLE 1

| | DOD | CIJ |
|---|---|---|
| Component | Black % | Blac [symbol] % |
| Fixative ABN Emulsion (SunChemical KVK) | 11.9 | 12 |
| Water | 11.7 | 46.85 |
| Surfynol 465 (Air Products) - Surfactant | 0.5 | — |
| Zonyl FSO 100 (DuPont) - Surfactant | — | 0.1 |
| FC130 (3M) - Surfactant | 0.1 | — |
| Propylene Glycol (Aldrich) - Humectant/thickener | 54.7 | 20 |
| Aux Clear LF (SunChemical KVK) | 0.7 | 0.7 |
| Byk 066 (BYK Chemie) - Defoamer | 0.5 | — |
| Cabojet 300 (Cabot) - Pigment dispersion | 19.9 | 20 |
| Foamex 840 (Tego) - Defoamer | — | 0.1 |
| Ammonium Sulphate (Aldrich) Conductivity | — | 0.25 |
| Agent | | |
| Viscosity | 11.9 | 3.56 |
| | cP | cP |
| Particle Size D [v, 0.99] | 0.42μ | — |
| Surface Tension | 29 | 25 |
| | dyn/cm | dyn/c [symbol] |
| Conductivity | — | 1.95 |
| | | mS/c [symbol] |

Water (460.2 g) and propylene glycol (2145 g) were mixed in a three litre beaker. Fixative ABN emulsion (468 g) and Aux Clear LF (27.3 g) were then added to the solution. In a separate 3L beaker, Cabojet 300 (780 g) was added prior to the gradual addition of the mixture above. This was followed by the introduction of BYK 066 (19.5 g), Surfynol 465 (19.5 g) and FC130 (3.9 g). The mixture was then stirred on a Silverson mixer for 2-3 minutes to give the DOD ink.

(b) Preparation of CIJ Ink

Water (941 g), Propylene glycol (400 g) and ammonium sulphate (5.0 g) were dissolved in a three litre beaker. Fixative ABN emulsion (240 g) and Aux Clear LF (14 g) were then added to the solution. In a separate 3 L beaker, Cabojet 300 (400 g) was added prior to the gradual addition of the mixture above. This was followed by the introduction of Foamex 840 (2 g) and Zonyl FSO 100 (2 g). The mixture was stirred on a Silverson mixer for 2-3 minutes to give the CIJ ink, which was then filtered to less than 1 μm

### EXAMPLE 2

A DOD ink formulation, which was identical to that in Table 1 except that a cyan pigment was included instead of the black pigment, was applied to cotton substrate using a typical DOD piezo print head and dried under standard conditions of 150° C. fo 3-4 minutes.

An Atlas Electric Devices model CM-1 Crockmeter from AATCC was used for ten passes on each print (5 cm×15 cm) with blank cotton substrate (5 cm×5 cm) soaked with or without 2 mls of water for dry or wet testing, respectively, according to AATCC test method 8-1989. The samples (10 cm×15 cm) were also tested in a washing machine for three cycles at 60° C. for 1.5 hours, using Empor Extra M* (trade mark—available from Henkel) washing powder. A portion of the prints was removed from the machine after one cycle, for assessment, prior to further washes. A typical grey scale-testing procedure was used for colour fade after testing. The hand of the material was noted subjectively.

For the purposes of comparison, a cyan DOD jet-ink was prepared in accordance with the DOD formulation of Table 1 except that the acrylic-butadiene emulsion polymer was replaced by a non-cross-linkable acrylic emulsion with a Tg of −8° C. or b a non-cross-linkable styrene-acrylic emulsion polymer with a Tg of 110° C. and the pigment was selected to generate the colour cyan. The comparison inks were similarly tested, along with a standard commercially available screen ink applied to an identical cotton substrate.

The results from crock and wash testing of the jet-ink formulation of the invention against the three comparison inks are presented in Table 2. The value of 1 in the crock tests indicates poor rub resistance and values of 3 or 4 indicate goo rub resistance. In the machine washing test, values of 1 or 2 indicate poor chemical and/or temperature resistance whilst values of 3 or 4 indicate good chemical and temperature resistance.

TABLE 2

| | | Styrene- | | |
|---|---|---|---|---|
| Test | Acrylic* | Acrylic** | Acrylic-Butadiene+ | Screen-Ink+ |
| Dry Crock | 1 | 1 | 3 | 3-4 |
| Wet Crock | 1 | 1 | 2-3 | 2-3 |
| Washing | | | | |
| Machine | | | | |
| 1 cycle | 1-2 | 1 | 4 | 4-5 |
| (grey-scale | | | | |
| value) | | | | |
| 3 cycles | 1 | 1 | 3 | 3 |
| (grey-scale | | | | |
| value) | | | | |
| hand | good | Poor | good | Good |

*Available SC Johnson under trade mark Joncryl 74
**Available SC Johnson under trade mark Joncryl 90
+Available SunChemical under trade mark PrintPaste 7219

The results indicate that, under dry and wet test conditions, the acrylic-butadiene cross-linker combination is superior to the acrylic emulsion formulation and to the non-cross-linkable styrene-acrylic emulsion polymer. Furthermore, the acrylic-butadiene formulation can perform at a similar level to the cyan screen ink standard that was applied without the use of ink jet printing.

### EXAMPLE 3

A number of DOD inks having the ingredients and physical characteristics shown in Table 3 were made in accordance with the method described in Example 1. The inks in Table 3 were found to print well from a DOD printer onto a textile substrate, and have good wet and dry fastness and good temperature and chemical resistance.

TABLE 3

| Component | Yellow | | magenta | | cyan | black |
|---|---|---|---|---|---|---|
| Fixative ABN Emulsion | 12 | 12 | 12 | 12 | 12 | 12 |
| Water | 27.7 | 27.3 | 60.75 | 36.65 | 13.15 | 32.8 |
| Surfynol 465 | 0.5 | 0.5 | | | | |
| Tegowet KL245 (Tego) | | | | | 1.0 | 1.0 |
| Propylene glycol | 50 | 52 | | 30 | 55 | 30 |
| Polyethylene glycol | | | 15 | 3 | | 3 |
| (Merck) | | | | | | |
| Aux Clear LF | 0.7 | 0.7 | 0.7 | 0.7 | 0.7 | 0.7 |
| Defoamer S | | | | | | 0.5 |
| (SunChemical KVK) | | | | | | |
| Foamex 605 (Tego) | | | | | 0.5 | |
| Foamex 3062 (Tego) | 0.5 | 0.5 | | | | |
| Cabojet 300 - pigment | | | | | | 20 |
| dispersion | | | | | | |
| Acryjet Magenta (Rohm & | | | | 17.65 | | |
| Haas) - pigment dispersion | | | | | | |
| Acryjet cyan (Rohm & | | | | | 17.65 | |
| Haas)- pigment dispersion | | | | | | |
| Hostafine yellow GR | 8.58 | | | | | |
| (Clariant) - pigment | | | | | | |
| dispersion | | | | | | |
| YJD 3174 (SunChemical) - | | 7.0 | | | | |
| pigment dispersion | | | | | | |
| QJD 3122 (SunChemical) - | | | 11.55 | | | |
| pigment dispersion | | | | | | |
| Viscosity | 11.7 | 15.2 | 12.6 | 11.5 | 10.9 | 12.3 |
| | cP | cP | cP | cP | cP | cP |
| Surface tension | | | | | | 30.5 |
| | | | | | | dyn/cm |

1. An ink jet ink for use in a process of ink jet printing upon a textile substrate comprising:
(a) an emulsion polymer selected from the group consisting of acrylic-acrylonitrile polymers, butadiene-acrylonitrile polymers, styrene-acrylic polymers, acrylic-butadiene polymers, and polyurethanes and having a glass transition temperature of not more than 50° C.;
(b) a cross-linking agent which is suitable for cross-linking the emulsion polymer;
(c) a pigment; and
(d) a liquid medium.

2. An ink jet ink according to claim 1, in which the cross-linking agent is present in an amount of from 1.5 to 20% by weight based on the weight of emulsion polymer.

3. An ink jet ink according to claim 1 or claim 2, which comprises up to 18% by weight emulsion polymer, based on the total weight of the ink.

4. An ink jet ink according to any one of claims 1 to 3, in which the liquid medium is an aqueous medium.

5. An ink jet ink according to any one of claims 1 to 4, which comprises from 5 to 18% by weight emulsion polymer, and up to 1 by weight cross-linker, up to 10% by weight pigment and up to 94% by weight water, based on the total weight of the ink.

6. An ink jet ink according to any one of claims 1 to 5, in which the emulsion polymer is an acrylic-butadiene polymer.

7. An ink jet ink according to any one of claims 1 to 6, which comprises at least 0.1% by weight cross-linker, based on the total weight of the ink.

8. An ink jet ink according to any one of claims 1 to 7, which comprises at least 0.1% by weight pigment, based on the total weight of the ink.

9. An ink jet ink according to any one of claims 1 to 8, in which the cross-linking agent is a melamine-formaldehyde cross-linking agent.

10. An ink jet ink according to any one of claims 1 to 9, which further comprises one or more additional ingredients selected from surfactants, humectants, defoamers, dispersants, conductivity agents, and thickeners.

11. An ink jet ink according to any one of claims 1 to 10, which has a viscosity at 25° C. of not more than 30 mPa.s.

12. An ink jet ink for us in a process of ink jet printing upon a textile material substrate, comprising an acrylic-butadiene emulsion polymer, a cross-linking agent for cross-linking the acrylic-butadiene emulsion polymer, a pigment, and an aqueous medium, the ink having a viscosity of not more than 30 mPa.s at 25° C.

13. An ink jet ink according to any one of the preceding claims, which is suitable for use in a drop on demand (DOD) ink jet printer.

14. An ink jet ink according to any one of the preceding claims, which is suitable for use in a continuous ink jet (CIJ) printer.

15. An ink jet ink substantially as described in Example 1 or Example 3 herein.

16. A method of printing on a textile substrate, comprising applying to the textile substrate by ink jet printing a formulation comprising:
(a) an emulsion polymer selected from the group consisting of acrylic-acrylonitrile polymers, butadiene-acrylonitrile polymers, styrene-acrylic polymers, acrylic-butadiene polymers, and polyurethanes and having a glass transition temperature of not more than 50° C.;
(b) a cross-linking agent which is suitable for cross-linking the emulsion polymer;
(c) a pigment; and
(d) an aqueous medium.

17. A method according to claim 16, in which the formulation is further in accordance with any one of claims 2 to 15.
